(19) United States
(12) Patent Application Publication
(10) Pub. No.: US 2005/0256236 A1
(43) Pub. Date: Nov. 17, 2005

(54) Pumpable composition comprising tricyclodecanedimethylol

(75) Inventors: Lars Wittkowski, Mannheim (DE); Rainer Papp, Speyer (DE)

Correspondence Address: CONNOLLY BOVE LODGE & HUTZ LLP, SUITE 800, 1990 M STREET NW, WASHINGTON, DC, 20036-3425, US

(73) Assignee: BASF AKTIENGESELLSCHAFT, Ludwigshafen (DE)

(21) Appl. No.: 11/126,182

(22) Filed: May 11, 2005

(30) Foreign Application Priority Data
May 11, 2004 (DE) 102004023071.4

(51) Int. Cl. C08F 20/06

(52) U.S. Cl. 524/379; 526/319; 526/317.1; 524/556

(57) ABSTRACT

Composition comprising tricyclodecanedimethylol and at least one polymerizable compound, preferably selected from (meth)acrylic acid, esters thereof, O— and N-vinyl compounds, epichlorohydrin, C₁— to C₁₀-alkylene oxides, in a ratio of from 100:1 to 1:1.

The invention relates to a pumpable composition comprising tricyclodecanetrimethylol which additionally comprises polymerizable compounds.

Tricyclodecanedimethylol (referred to hereinbelow as TCD-dimethylol) is a widespread raw material for the preparation of acrylates or epoxy resins. Among other uses, the polyacrylates and epoxy resins produced therefrom are used in paints, inks and coatings having good adhesion, and high heat, weathering and impact resistance.

In commercial quality, TCD-dimethylol is so highly viscous even at room temperature that it is not directly pumpable. Manufacturers of subsequent products are therefore forced to initially melt TCD-dimethylol in order then to be able to pump it out of the delivery container. This time and energy requirement is uneconomic.

It is an object of the present invention to avoid this disadvantage.

Surprisingly, it has now been found that a composition comprising tricyclodecanedimethylol (I) 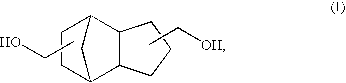
and at least one polymerizable, preferably at least one monounsaturated, compound in a weight ratio of from 100:1 to 1:1, preferably from 20:1 to 3:1, is pumpable at room temperature without being melted. It is also advantageous that there are no reactions at this temperature, for example polymerizations. Room temperature refers to a temperature of from 15 to 30° C.

The polymerizable compound is preferably selected from methacrylic and acrylic acid (referred to hereinbelow as (meth)acrylic acid), esters thereof, O— and N-vinyl compounds, C₁— to C₁₀-alkylene oxides, for example ethylene oxide, propylene oxide, and epichlorohydrin.

The (meth)acrylic acid which can be used is not restricted and may, in the case of crude (meth)acrylic acid, for example, have the following components:

| | | |
|---|---|---|
| (Meth)acrylic acid | 90-99.9% | by weight |
| Acetic acid | 0.05-3% | by weight |
| Propionic acid | 0.01-1% | by weight |
| Diacrylic acid | 0.01-5% | by weight |
| Water | 0.05-5% | by weight |
| Aldehydes | 0.01-0.3% | by weight |
| Inhibitors | 0.01-0.1% | by weight |
| Maleic acid/anhydride | 0.001-0.5% | by weight |

The crude (meth)acrylic acid used is generally stabilized with 200-600 ppm of phenothiazine or other stabilizers in amounts which enable comparable stabilization.

Crude (meth)acrylic acid refers here to the (meth)acrylic acid-containing mixture which is obtained after absorption of the reaction gases of the propane/propene/acrolein or isobutane/isobutene/methacrolein oxidation in an absorbent and subsequent removal of the absorbent, or is obtained by fractional condensation of the reaction gases.

It will be appreciated that it is also possible to use pure (meth)acrylic acid having, for example, the following purity:

| | | |
|---|---|---|
| (Meth)acrylic acid | 99.7-99.99% | by weight |
| Acetic acid | 50-1000 | ppm by weight |
| Propionic acid | 10-500 | ppm by weight |
| Diacrylic acid | 10-500 | ppm by weight |
| Water | 50-1000 | ppm by weight |
| Aldehydes | 1-500 | ppm by weight |
| Inhibitors | 1-300 | ppm by weight |
| Maleic acid/anhydride | 1-200 | ppm by weight |

The pure (meth)acrylic acid used is generally stabilized with 100-300 ppm of hydroquinone monomethyl ether or other storage stabilizers in amounts which enable comparable stabilization.

Pure or prepurified (meth)acrylic acid generally refers to (meth)acrylic acid whose purity is at least 99.5% by weight and which is substantially free of the aldehydic, other carbonylic and high-boiling components.

O-Vinyl compounds or N-vinyl compounds refer to a heterosubstituted vinyl monomer which bears oxygen or nitrogen as a heteroatom on the vinyl group. Examples of heterosubstituted vinyl monomers are vinylcarboxylic esters such as vinyl acetate, vinyl propionate or vinyl butyrate, vinyl ethers such as methyl vinyl ether, ethyl vinyl ether or butyl vinyl ether, triethylene glycol divinyl ether, hydroxyalkyl vinyl ethers such as hydroxybutyl vinyl ether and cycloalkyl vinyl ethers such as cyclohexyl vinyl ether, and also vinylcarbazoles, vinylpyrrolidones, vinylphthalimides, vinylcaprolactams, vinylimidazoles and vinylformamide.

In a further embodiment of the inventive composition, at least one polymerizable compound is defined by the general formula (II) 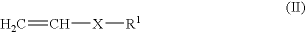
where the symbols are each defined as follows
X is O or NR², 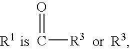
R² is hydrogen or C₁-C₄-alkyl or, together with R³, forms a C₃—, C₄— or C₅-alkylene bridge or alkenylene bridge, in each of which up to two nonadjacent CH₂ groups may be replaced by NH, N(C₁-C₄-alkyl), N(C₆-C₁₀-aryl) or oxygen and up to two nonadjacent CH groups may be replaced by N and
R³ is hydrogen or a mono- or poly-hydroxy-substituted or -vinyloxy-substituted or unsubstituted C₁-C₁₆-alkyl, C₆-C₁₆-cycloalkyl or C₁-C₄-alkyl-C₆-C₁₂-cycloalkyl group or, together with R², is a C₃—, C₄— or C₅-alkylene bridge, in each of which up to two nonadjacent CH₂ groups may be replaced by NH, N(C₁-C₄-alkyl), N(C₆-C₁₀-aryl) or oxygen and up to two nonadjacent CH groups may be replaced by N.

In the polymerizable compounds of the general formula (II) which may be present in the inventive composition, X is preferably oxygen. Vinyl ethers in which R¹ is a C₁-C₄-alkyl group, i.e. methyl, ethyl, n-propyl, isopropyl, n-butyl, isobutyl, sec-butyl or tert-butyl, constitute preferred polymerizable compounds. Preference is further given to vinyl ethers in which R¹ is a C₁-C₄-hydroxyalkyl group or a C₁-C₄-alkyl group, each of which is mono-vinyloxy-substituted.

Further embodiments of the inventive composition are those which comprise triethylene glycol divinyl ether (DVE), 4-hydroxybutyl vinyl ether and/or cyclohexyl vinyl ether as the polymerizable compound. When X is defined as NR₂, R¹ is preferably a CO—R³ group.

In addition to hydrogen and the C₁-C₄-alkyl groups mentioned, useful R³ radicals are also those which, together with NR2, form a saturated or unsaturated 5- to 7-membered ring. Examples of such ring systems are those of the general formula (III)

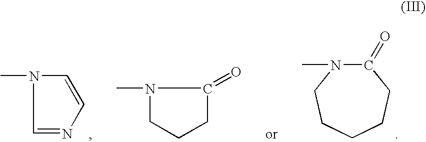

In a further embodiment of the inventive composition, X—R¹ is NH₂COCH₃, N-imidazolyl, N-pyrrolidinonyl or N-caprolactamyl.

Preferentially suitable among the esters of (meth)acrylic acid are C₁— to C₈-alkyl esters such as the methyl, the butyl or the 2-ethylhexyl esters.

In a further embodiment, the inventive composition may consist of TCD-dimethylol and polymerizable compound, and impurities and stabilizers in the trace region, typical for the preparation of the polymerizable compound, as specified above, for example, for crude (meth)acrylic acid, are also included.

In a further embodiment, from 1 to 30% by weight, preferably from 5 to 20% by weight, of a solvent are added to the inventive composition.

Useful solvents are C₁— to C₈-alcohols, ethers, C₁— to C₁₄-hydrocarbons for example methanol, ethanol, isopropanol, butanol, 2-ethylhexanol, dioxane, tetrahydrofuran, ethylene glyol dimethyl ether, cyclohexane and pentane; preference is given to methanol, butanol, 2-ethylhexanol, tetrahydrofuran and ethylene glycol dimethyl ether.

The inventive composition is prepared by mixing the TCD-dimethylol with polymerizable compound and, if appropriate, solvent, preferably with the aid of customary stirrer apparatus. Tricyclodecanedimethylol is obtainable as a commercial product, for example from Celanese Chemicals Europe GmbH, Lurgiallee 14, 60439 Frankfurt a. M., Germany.

The inventive composition relieves polymer manufacturers which want to use tricyclodecanedimethylol, for example for preparing acrylates or epoxy resins, of the time- and cost-intensive melting of the highly viscous substance.

The invention is illustrated in detail by the examples which follow.

### EXAMPLES

Viscosity Measurement

The viscosities were measured using a rotational viscometer to DIN 53018. The Rotoviso RV20 from Haake, measuring system M5, measuring geometry MVI and MVII was used.

### Example 1

### Commercial TCD-dimethylol

The viscosities of commercial TCD-dimethylol were determined at 50 and 75° C. At 50° C., a viscosity of 16 500 mPas was measured, at 75° C. a viscosity of 1100 mPas.

### Example 2

### Inventive Composition

TCD-Dimethylol, methyl acrylate and, if appropriate, methanol are mixed together in the weight ratios specified in Table 1. The values of the viscosities at 25° C. can likewise be taken from Table 1.

TABLE 1

| | TCD-Dimethylol | Methyl acrylate | Methanol | Viscosity |
|---|---|---|---|---|
| Example | [g] | [g] | [g] | [mPas] |
| 1 | 90 | 10 | 0 | 8340 |
| 2 | 90 | 5 | 5 | 3930 |
| 3 | 80 | 20 | 0 | 687 |
| 4 | 80 | 10 | 10 | 298 |
| 5 | 70 | 30 | 0 | 122 |
| 6 | 70 | 15 | 15 | 51 |

1. A composition comprising tricyclodecanedimethylol and at least one polymerizable compound in a weight ratio of from 100:1 to 1:1.

2. The composition according to claim 1, wherein the polymerizable compound is selected from the group consisting of (meth) acrylic acid, esters thereof, O— and N-vinyl compounds, alkylene oxides, and epichlorohydrin.

3. The composition according to claim 1, wherein tricyclodecanedimethylol and polymerizable compound are present in a weight ratio of from 20:1 to 3:1.

4. The composition according to claim 1, wherein a solvent is additionally present.

5. The composition according to any of claim 1, wherein the solvent is selected from the group consisting of tetrahydrofuran, methanol, butanol, ethylhexanol, and ethylene glycol dimethyl ether.

6. A method of using the composition according to claim 1 comprising using said composition for preparing acrylate and epoxy resins.

7. The composition according to claim 2, wherein tricyclodecanedimethylol and polymerizable compound are present in a weight ratio of from 20:1 to 3:1.

8. The composition according to claim 2, wherein a solvent is additionally present.

9. The composition according to claim 3, wherein a solvent is additionally present.

10. The composition according to claim 2, wherein the solvent is selected from the group consisting of tetrahydrofuran, methanol, butanol, ethylhexanol, and ethylene glycol dimethyl ether.

11. The composition according to claim 3, wherein the solvent is selected from the group consisting of tetrahydrofuran, methanol, butanol, ethylhexanol, and ethylene glycol dimethyl ether.

12. The composition according to claim 4, wherein the solvent is selected from the group consisting of tetrahydrofuran, methanol, butanol, ethylhexanol, and ethylene glycol dimethyl ether.
